(19) United States
(12) Patent Application Publication
(10) Pub. No.: US 2026/0025575 A1
(43) Pub. Date: Jan. 22, 2026

(54) IMAGING DEVICE AND METHOD FOR CONTROLLING IMAGING DEVICE

(71) Applicant: CANON KABUSHIKI KAISHA, Tokyo (JP)

(72) Inventor: MASAHIRO SHINDO, Kanagawa (JP)

(21) Appl. No.: 19/266,847

(22) Filed: Jul. 11, 2025

(30) Foreign Application Priority Data
Jul. 18, 2024 (JP) 2024-114878

(51) Int. Cl. H04N 23/66; H04N 23/60; H04N 23/61; H04N 23/695

(52) U.S. Cl. CPC H04N 23/66; H04N 23/61; H04N 23/64; H04N 23/695

(57) ABSTRACT

An imaging device according to the present disclosure includes: a processor; and a memory storing a program which, when executed by the processor, causes the imaging device to: execute acceptance processing of accepting a photographing instruction by a word; execute an acquisition processing of acquiring a reference image based on the word of the photographing instruction; execute notification processing of presenting the reference image to a user; and execute control processing of performing control to perform photographing based on the reference image.

### BACKGROUND

### Field of the Technology

The present disclosure relates to an imaging device and a method for controlling the imaging device.

### Description of the Related Art

In recent years, an automatic photographing camera that periodically and continuously photographs a detected object without a user performing a photographing operation has been developed, and the automatic photographing camera has been put into practical use.

In the automatic photographing camera, since the camera itself determines whether to photograph instead of the operation by the user, a picture and a moving image expected by the user may not be photographed. In a case where the picture and the moving image expected by the user are not photographed, it is desirable that the automatic photographing camera accepts a photographing instruction from the user and reflects the photographing instruction in subsequent automatic photographing.

Japanese Patent Laid-Open No. 2008-311819 discloses an image photographing device that automatically determines an appropriate photographing timing by using recognition of smile from an object included in an image. A user can set a smile detection level of the object serving as a photographing condition.

Even when the smile detection level can be set, the user does not know an extent of smile that corresponds to the set level until the user confirms the automatically photographed image. In addition, in a case where a desired image is not photographed, it is difficult for the user to determine whether the automatic photographing camera has erroneously interpreted a photographing instruction or whether the photographing instruction has been correctly interpreted but there was no photographing opportunity.

### SUMMARY

The present disclosure is directed to provide an imaging device that enables a user to confirm in advance whether a desired image is to be photographed in automatic photographing based on a photographing instruction from the user.

An imaging device according to the present disclosure includes: a processor; and a memory storing a program which, when executed by the processor, causes the imaging device to: execute acceptance processing of accepting a photographing instruction by a word; execute an acquisition processing of acquiring a reference image based on the word of the photographing instruction; execute notification processing of presenting the reference image to a user; and execute control processing of performing control to perform photographing based on the reference image.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of an automatic photographing system according to a first embodiment.

FIG. 2 is a diagram illustrating a hardware configuration of the automatic photographing system according to the first embodiment.

FIG. 3A is a diagram illustrating a functional configuration of a feature estimation server according to the first embodiment.

FIG. 3B is a diagram illustrating a functional configuration of a reference image generation server according to the first embodiment.

FIG. 3C is a diagram illustrating a functional configuration of an automatic photographing camera according to the first embodiment.

FIGS. 4A and 4B are diagrams illustrating prompts transmitted and received by the feature estimation server.

FIGS. 5A and 5B are diagrams for describing generation of a reference image.

FIG. 6 is a diagram for describing an operation of the automatic photographing camera.

FIG. 7A is a flowchart illustrating photographing control processing of the automatic photographing camera.

FIG. 7B is a flowchart illustrating processing of the feature estimation server.

FIG. 7C is a flowchart illustrating processing of the reference image generation server.

FIG. 8 is a flowchart illustrating the photographing control processing based on the reference image.

FIG. 9 is a diagram illustrating a configuration of an automatic photographing system according to a second embodiment.

FIG. 10 is a diagram illustrating a hardware configuration of a reference image search server.

FIG. 11 is a diagram illustrating a combination of an image and a feature of the image.

FIG. 12 is a diagram illustrating a functional configuration of a reference image search server according to a second embodiment.

FIG. 13 is a diagram illustrating a prompt received by the reference image search server.

FIG. 14 is a flowchart illustrating reference image search processing.

### DESCRIPTION OF THE EMBODIMENTS

### First Embodiment

Hereinafter, embodiments of the present disclosure will be described with reference to the drawings. The components described in the following embodiments are exemplary, and the scope of the present disclosure is not limited to these embodiments. All of the plurality of features described in each embodiment are not necessarily required and may be arbitrarily combined.

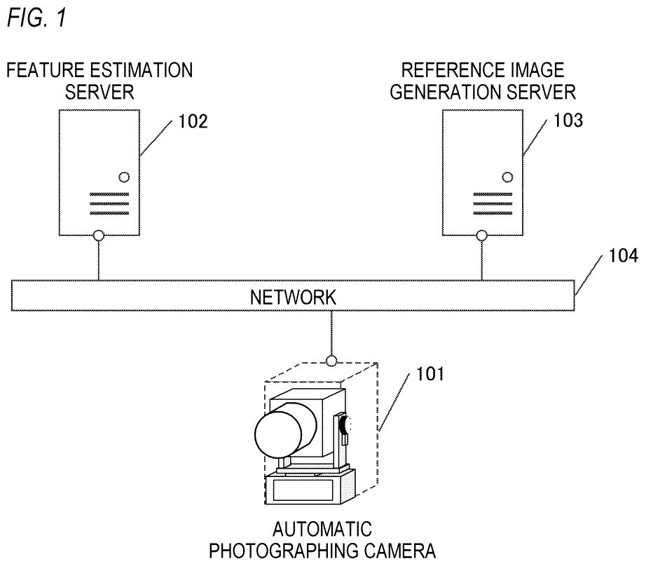

(System Configuration) FIG. 1 is a diagram illustrating a configuration of an automatic photographing system according to a first embodiment. In the example of FIG. 1, the automatic photographing system includes an automatic photographing camera 101, a feature estimation server 102, and a reference image generation server 103. The automatic photographing camera 101, the feature estimation server 102, and the reference image generation server 103 can communicate with each other via a network 104 such as the Internet. Note that a part of processing of the feature estimation server 102 and the reference image generation server 103 may be executed by the automatic photographing camera 101. In addition, the feature estimation server 102 and the reference image generation server 103 may be configured integrally with the automatic photographing camera 101. That is, the function of each server may be implemented by the automatic photographing camera 101.

The automatic photographing camera 101 is an imaging device that can accept a photographing instruction by a word from a user and automatically photograph an image according to the photographing instruction. The feature estimation server 102 and the reference image generation server 103 are information processing devices such as personal computers (PCs). The feature estimation server 102 estimates a feature of an image to be photographed based on the photographing instruction by the user. The feature estimation server 102 transmits the estimated feature of the image to the automatic photographing camera 101. The reference image generation server 103 generates a reference image based on the feature of the image estimated by the feature estimation server 102. The reference image is a confirmation image for the user to confirm what kind of image is to be photographed in a case where the automatic photographing camera 101 performs photographing based on the photographing instruction. The reference image generation server 103 transmits the generated reference image to the automatic photographing camera 101.

When accepting a photographing instruction from the user, the automatic photographing camera 101 transmits the photographing instruction to the feature estimation server 102. When receiving the feature of the image estimated by the feature estimation server 102, the automatic photographing camera 101 transmits the received feature of the image to the reference image generation server 103. When receiving the reference image from the reference image generation server 103, the automatic photographing camera 101 displays the reference image on a display unit included in the automatic photographing camera 101. The automatic photographing camera 101 may transmit the reference image to an external device including a display unit to display the reference image.

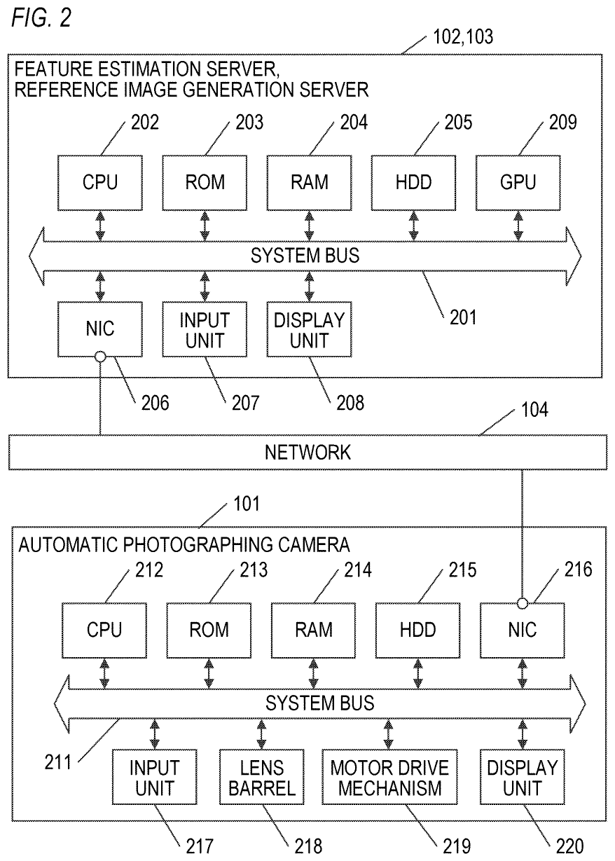

(Hardware Configuration) FIG. 2 is a diagram illustrating a hardware configuration of each device included in the automatic photographing system of FIG. 1. The feature estimation server 102 and the reference image generation server 103 have the same configuration. Each configuration of the feature estimation server 102 will be described below. The reference image generation server 103 has a similar configuration as the feature estimation server 102.

The feature estimation server 102 includes a CPU 202, a ROM 203, a RAM 204, an HDD 205, a network interface card (NIC) 206, an input unit 207, a display unit 208 (display), and a GPU 209. The components are connected to each other via a system bus 201.

The CPU 202 implements various functions of the feature estimation server 102 by developing a program stored in the ROM 203 into the RAM 204 and executing the program. The ROM 203 stores various programs for implementing processing executed by the feature estimation server 102. The RAM 204 temporarily stores data used by various programs. The HDD 205 stores a learned machine learning model and the like.

The NIC 206 is connected to the network 104. The NIC 206 transmits and receives data to and from the external automatic photographing camera 101 and the like via the network 104. The NIC 206 includes a communication circuit capable of communicating in a communication scheme conforming to various standards for transmitting and receiving information via the Internet, a dedicated line, or the like.

The input unit 207 includes an input device such as a keyboard and a mouse that accepts an input operation with respect to the feature estimation server 102. The display unit 208 displays various types of information on the feature estimation server 102.

Compared to the CPU 202, the GPU 209 can process more data in parallel, and thus can perform efficient calculation. The GPU 209 is used, for example, for processing using a machine learning model. The processing using the machine learning model may be executed using the GPU 209 in addition to the CPU 202. Furthermore, the processing using the machine learning model may be executed using either the CPU 202 or the GPU 209.

The automatic photographing camera 101 includes a CPU 212, a ROM 213, a RAM 214, an HDD 215, an NIC 216, an input unit 217, a lens barrel 218, a motor drive mechanism 219, and a display unit 220. The components are connected to each other via a system bus 211.

The CPU 212 implements various functions of the automatic photographing camera 101 by developing a program stored in the ROM 213 into the RAM 214 and executing the program. The ROM 213 stores various programs for implementing processing executed by the automatic photographing camera 101. The RAM 214 temporarily stores data used by various programs. The HDD 215 stores various data such as a compressed image signal and a compressed audio signal generated by the automatic photographing camera 101.

The NIC 216 is connected to the network 104. The NIC 216 transmits and receives data to and from the external feature estimation server 102, the reference image generation server 103, and the like via the network 104. The NIC 216 includes a communication circuit capable of communicating in a communication scheme conforming to various standards for transmitting and receiving information via the Internet, a dedicated line, or the like.

The input unit 217 (acceptance unit) includes an operation member such as a button and a touch panel that accepts an input operation with respect to the automatic photographing camera 101. Furthermore, the input unit 217 includes an imaging element that receives light incident through each lens group and acquires information of electric charge according to the amount of received light as analog image data. Furthermore, the input unit 217 includes a microphone that performs analog conversion of an audio signal around the automatic photographing camera 101 and acquires the audio signal.

The lens barrel 218 includes a zoom lens that optically performs magnification change and a lens that performs focus adjustment. The lens barrel 218 can be rotationally driven with respect to a fixed portion of the automatic photographing camera 101. The motor drive mechanism 219 is a mechanism for rotating the lens barrel 218 in a pitch direction or a yaw direction. The motor drive mechanism 219 can pan/tilt rotate the lens barrel 218.

The display unit 220 includes a display panel such as an organic light emitting diode (OLED). The display unit 220 displays a screen for operating the automatic photographing camera 101, various types of information of the automatic photographing camera 101, and the like.

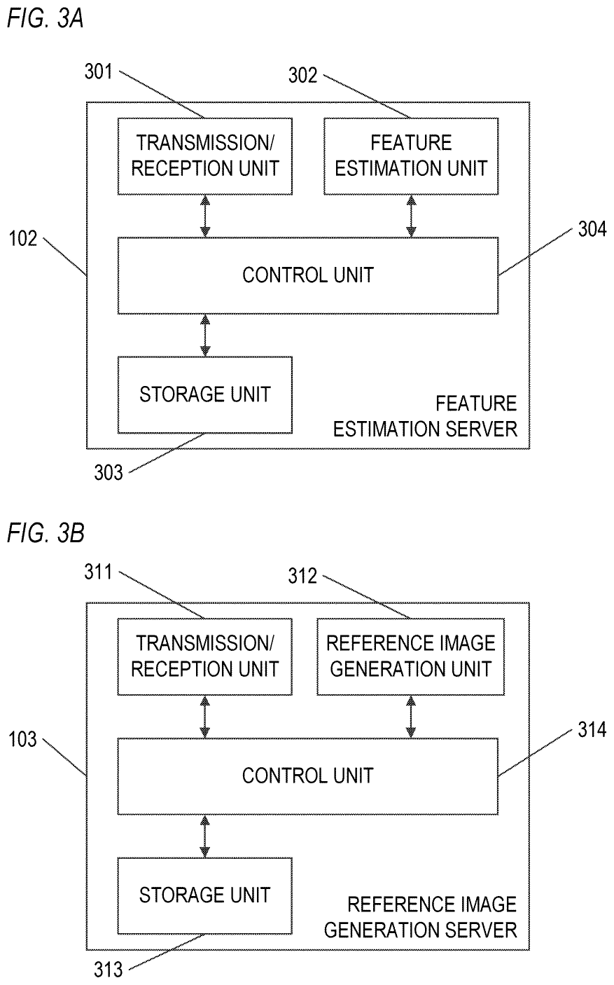

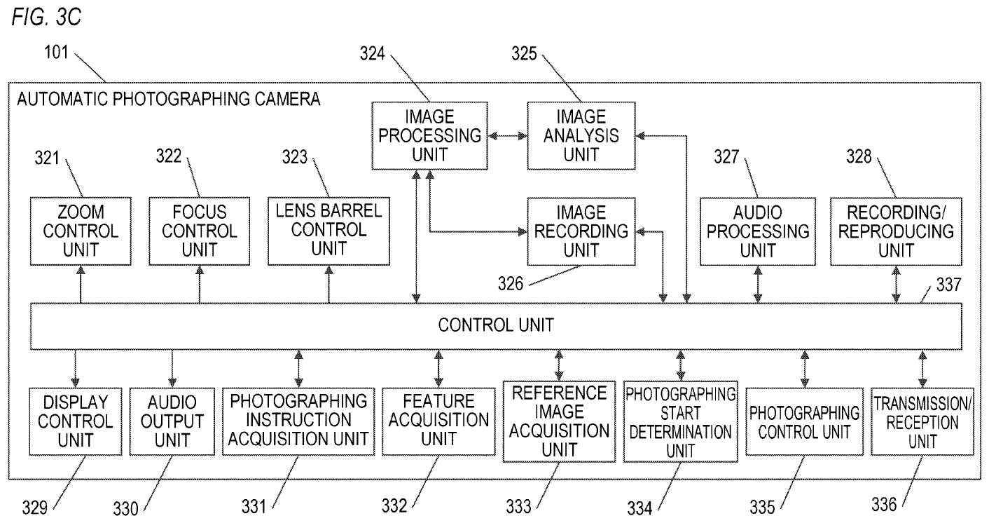

(Functional Configuration) FIG. 3A is a diagram illustrating a functional configuration of the feature estimation server 102. Each functional unit of the feature estimation server 102 is implemented by the CPU 202 developing the program stored in the ROM 203 into the RAM 204 and executing the program. The feature estimation server 102 includes a transmission/reception unit 301, a feature estimation unit 302, a storage unit 303, and a control unit 304.

The transmission/reception unit 301 communicates with the automatic photographing camera 101 to transmit and receive various data. For example, the transmission/reception unit 301 receives a prompt transmitted from the automatic photographing camera 101 and transmits the feature of the image to be photographed estimated by the feature estimation unit 302 to the automatic photographing camera 101.

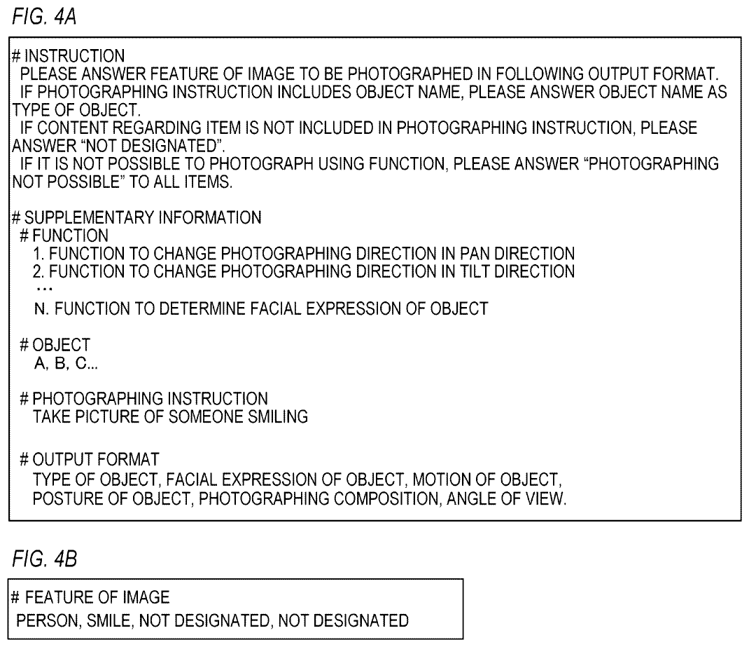

FIG. 4A is a diagram illustrating a prompt regarding a photographing instruction received by the feature estimation server 102 from the automatic photographing camera 101. The prompt given by the automatic photographing camera 101 to the feature estimation server 102 is an instruction or an input given to a program and an AI model. The prompt given to the feature estimation server 102 includes an image feature estimation instruction and supplementary information for supplementing the estimation instruction. The supplementary information is, for example, a function of the automatic photographing camera 101, an object, a photographing instruction, and an output format of a feature of an image. The prompt may be in a data format such as JSON (JavaScript (trademark) Object Notation).

The feature estimation unit 302 estimates a feature of an image to be photographed by the automatic photographing camera 101 based on the prompt received from the automatic photographing camera 101. The feature of the image is information serving as a determination material for determining an object to be photographed by the automatic photographing camera 101 and a timing of photographing. Examples of the feature of the image include a type of an object, a facial expression of an object, a motion of an object, a posture of an object, a photographing composition, an angle of view, and the like. FIG. 4B is a diagram illustrating a prompt regarding the feature of the image transmitted by the feature estimation server 102 to the automatic photographing camera 101. In the example of FIG. 4B, “person” is designated as the type of the object, and “smile” is designated as the facial expression of the object. The feature of the image may be in a data format such as JSON.

The feature estimation unit 302 may estimate the feature of the image to be photographed based on the input photographing instruction using a learning model such as generative AI, for example. The learning model used for the estimation of the feature of the image may be, for example, a model obtained by finely tuning a model obtained by learning a pattern of a general-purpose language from large-scale text data by preliminary learning by causing to additionally learn data corresponding to a task of estimating a feature of an image. The feature estimation unit 302 may estimate a feature of an image to be photographed by using an existing generative AI service. The feature estimation unit 302 may use, for example, ChatGPT or the like as the generative AI service.

The storage unit 303 stores the learned model. The control unit 304 executes various processing to control each functional unit of the feature estimation server 102 and control data transfer between the functional units.

FIG. 3B is a diagram illustrating a functional configuration of the reference image generation server 103. Each functional unit of the reference image generation server 103 is implemented by the CPU 202 developing the program stored in the ROM 203 into the RAM 204 and executing the program. The reference image generation server 103 includes a transmission/reception unit 311, a reference image generation unit 312, a storage unit 313, and a control unit 314.

The transmission/reception unit 311 communicates with the automatic photographing camera 101 to transmit and receive various data. For example, the transmission/reception unit 311 receives a prompt transmitted from the automatic photographing camera 101 and transmits a reference image generated by the reference image generation unit 312 to the automatic photographing camera 101. When the reference image is displayed on the external device, the transmission/reception unit 311 transmits the reference image generated by the reference image generation unit 312 to the external device.

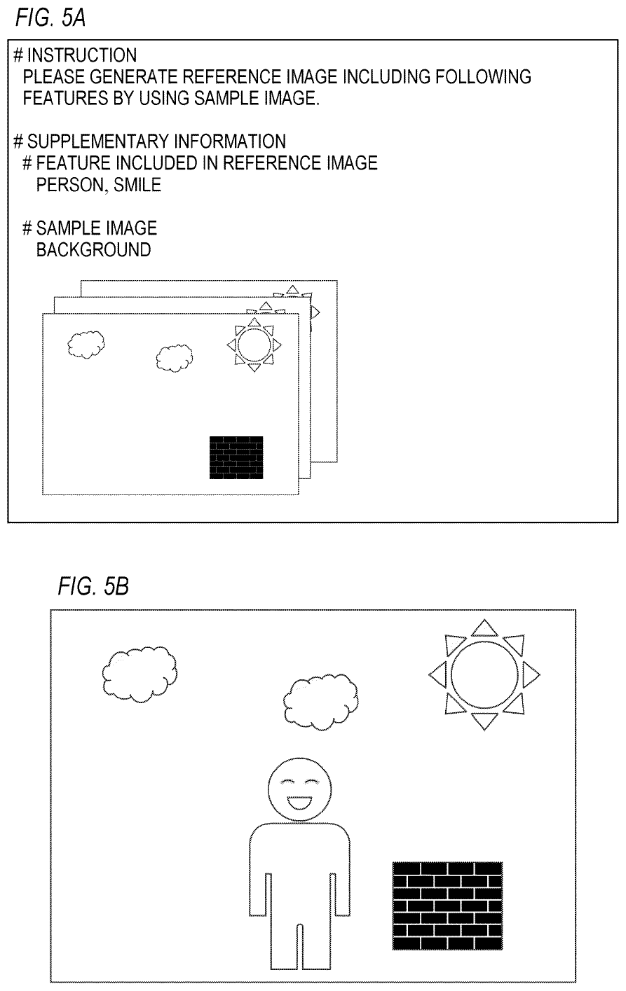

FIG. 5A is a diagram illustrating a prompt received by the reference image generation server 103 from the automatic photographing camera 101. The prompt given by the automatic photographing camera 101 to the reference image generation server 103 includes a reference image generation instruction and supplementary information for supplementing the generation instruction. The supplementary information is, for example, a feature included in the reference image to be generated, and a sample image used for generating the reference image. In the example of FIG. 5A, the features included in the reference image are “person” and “smile”. The sample image is an image used as a background of the reference image.

The reference image generation unit 312 generates a reference image based on a prompt regarding generation of the reference image. The reference image is generated as an example of an image assumed to be photographed when the automatic photographing camera 101 performs photographing based on a photographing instruction. By confirming the reference image, the user can confirm what kind of image is to be automatically photographed based on the photographing instruction. FIG. 5B is a diagram illustrating a reference image. The reference image generation unit 312 can generate a reference image as illustrated in FIG. 5B in which a smiling person appears with a sample image as a background based on the prompt illustrated in FIG. 5A.

The sample image is used by the reference image generation server 103 to generate a reference image. The sample image is, for example, an image obtained by photographing surroundings by the automatic photographing camera 101. In addition, the sample image may be an image photographed in the past so as to match the photographing instruction (an image photographed so as to indicate a feature estimated based on a word of a photographing instruction). The image photographed in the past so as to match the photographing instruction is recorded and accumulated in the HDD 215.

The reference image generation unit 312 may generate the reference image based on the feature of the input image by using a learning model such as generative AI, for example. The learning model used for the generation of the reference image may be, for example, a model obtained by finely tuning a model obtained by learning a generation pattern of an image from large-scale text data by preliminary learning by causing to additionally learn data corresponding to a task of generating a reference image.

The reference image generation unit 312 may generate a reference image by using an existing image generative AI service. The reference image generation unit 312 may use, for example, Stable Diffusion or the like as the image generative AI service.

The storage unit 313 stores the learned model. The control unit 314 executes various processing to control each functional unit of the reference image generation server 103 and control data transfer between the functional units.

FIG. 3C is a diagram illustrating a functional configuration of the automatic photographing camera 101. Each functional unit of the automatic photographing camera 101 is implemented by the CPU 212 developing the program stored in the ROM 213 into the RAM 214 and executing the program.

The automatic photographing camera 101 includes a zoom control unit 321, a focus control unit 322, a lens barrel control unit 323, an image processing unit 324, an image analysis unit 325, an image recording unit 326, an audio processing unit 327, and a recording/reproducing unit 328. In addition, the automatic photographing camera 101 includes a display control unit 329, an audio output unit 330, a photographing instruction acquisition unit 331, a feature acquisition unit 332, a reference image acquisition unit 333, a photographing start determination unit 334, a photographing control unit 335, a transmission/reception unit 336, and a control unit 337.

The zoom control unit 321 drives the zoom lens included in the lens barrel 218. The focus control unit 322 drives the lens included in the lens barrel 218. The lens barrel control unit 323 mechanically drives the lens barrel 218 in a tilt direction and a pan direction. The photographing control unit 335 can change a photographing direction of the automatic photographing camera 101 by rotationally driving the lens barrel 218 by the lens barrel control unit 323.

The image processing unit 324 performs A/D conversion on analog image data acquired from the imaging element as the input unit 217. The image processing unit 324 applies image processing such as distortion correction, white balance adjustment, and color interpolation processing to the A/D-converted digital image data. The image processing unit 324 outputs the digital image data to which various image processing has been applied to the image analysis unit 325 and the image recording unit 326.

The image analysis unit 325 performs image analysis on the digital image data output from the image processing unit 324 to detect an object. Furthermore, the image analysis unit 325 detects a facial expression of the object, a posture of the object, and the like.

The image analysis unit 325 detects, for example, a face of a person as an object from the image obtained by performing image processing for detecting the object by the image processing unit 324 on a signal captured by the imaging element as the input unit 217. The image analysis unit 325 can detect a portion matching a pattern in the image as the face of the person by using a predetermined pattern for determining a face of a person.

The image analysis unit 325 can detect a facial expression of the person after detecting the face of the person. The image analysis unit 325 can detect a facial expression of a pattern having a higher matching degree with the detected face of the person as the facial expression of the person by using a predetermined pattern for determining a facial expression of a person.

Furthermore, the image analysis unit 325 can detect a posture of the person after detecting the face of the person. The image analysis unit 325 can detect a posture of a pattern having a higher matching degree with the detected posture of the person as the posture of the person by using a predetermined pattern for determining a posture of a person.

The image analysis unit 325 may detect the object, the facial expression of the object, the posture of the object, and the like by using a learning model such as a neural network in which image data regarding a detection target is learned by machine learning.

The image recording unit 326 converts the digital image data output from the image processing unit 324 into a recording format such as a JPEG format and records the converted data in the HDD 215.

The audio processing unit 327 performs A/D conversion on an analog audio signal acquired from a microphone as the input unit 217. The audio processing unit 327 applies processing regarding audio such as optimization processing to the A/D-converted digital audio signal.

The image processing unit 324 reads out an image signal temporarily stored in the RAM 214 and encodes the image signal to generate a compressed image signal. The audio processing unit 327 reads out an audio signal temporarily stored in the RAM 214 and encodes the audio signal to generate a compressed audio signal.

The recording/reproducing unit 328 records the compressed image signal generated by the image processing unit 324, the compressed audio signal generated by the audio processing unit 327, other control data regarding imaging, and the like. The recording/reproducing unit 328 may record the image signal generated by the image processing unit 324 and the audio signal generated by the audio processing unit 327 in the HDD 215 without performing compression encoding.

Furthermore, the recording/reproducing unit 328 can read the compressed image signal, the compressed audio signal, the image signal, and the audio signal recorded in the HDD 215. The recording/reproducing unit 328 reads out the compressed image signal from the HDD 215 and transmits the signal to the image processing unit 324, or reads out the compressed audio signal and transmits the signal to the audio processing unit 327. The image processing unit 324 decodes the compressed image signal received from the recording/reproducing unit 328 by a predetermined procedure, and transmits the decoded signal to the display control unit 329. The audio processing unit 327 decodes the compressed audio signal received from the recording/reproducing unit 328 by a predetermined procedure, and transmits the decoded signal to the audio output unit 330.

The display control unit 329 displays various types of information of the automatic photographing camera 101. The display control unit 329 outputs, for example, the image signal transmitted by the image processing unit 324 or the image signal of the reference image acquired by the reference image acquisition unit 333 to the display unit 220. The audio output unit 330 outputs the audio signal received from the audio processing unit 327 or the audio signal of the reference image acquired by the reference image acquisition unit 333.

The photographing instruction acquisition unit 331 acquires, as a photographing instruction, an operation by the button of the input unit 217 or the audio signal processed by the audio processing unit 327. The photographing instruction is a word expressing what kind of image the user wants the automatic photographing camera 101 to photograph. The word of the photographing instruction may be a sentence. The photographing instruction includes an instruction on an object to be photographed, a facial expression of the object to be photographed, a posture of the object to be photographed, a photographing angle of view, a composition, and the like. For example, the photographing instruction is a word such as “take a picture if someone is smiling”, “take a picture so that a sleeping child is at a center of an angle of view”, and the like.

The feature acquisition unit 332 acquires a feature of the image to be photographed by the automatic photographing camera 101 based on the photographing instruction acquired by the photographing instruction acquisition unit 331. The feature acquisition unit 332 creates a prompt for instructing estimation of the feature of the image to be photographed based on the input photographing instruction and automatic photographing camera information. The automatic photographing camera information includes information on a photographing control function available in the automatic photographing camera 101. The photographing control function is, for example, a function of changing an imaging direction, a function of determining a facial expression of an object, or the like. In addition, the automatic photographing camera information includes information such as an object name of the object registered as a photographing target.

The feature acquisition unit 332 transmits the created prompt to the feature estimation server 102 via the transmission/reception unit 336. The feature acquisition unit 332 receives, via the transmission/reception unit 336, the feature of the image to be photographed estimated by the feature estimation server 102 based on the prompt.

The reference image acquisition unit 333 acquires a reference image based on the feature of the image acquired by the feature acquisition unit 332. That is, the reference image acquisition unit 333 acquires a reference image based on the word of the photographing instruction. The reference image acquisition unit 333 creates a prompt for instructing generation of the reference image based on the feature of the image acquired by the feature acquisition unit 332 and the sample image. The reference image acquisition unit 333 transmits the created prompt to the reference image generation server 103 via the transmission/reception unit 336. The reference image acquisition unit 333 receives, via the transmission/reception unit 336, the reference image generated by the reference image generation server 103 based on the prompt.

Image data of the surroundings of the automatic photographing camera 101 is acquired by the image processing unit 324 processing an image photographed by rotating the lens barrel 218 in the pan direction or the tilt direction by the lens barrel control unit 323. In addition, image data of the object recorded in the HDD 215 is acquired by the reference image acquisition unit 333 searching for image data to which a tag of an object name included in the feature of the image is added via the recording/reproducing unit 328.

The photographing start determination unit 334 determines whether the reference image acquired by the reference image acquisition unit 333 matches the photographing instruction (whether the reference image indicates the feature estimated based on the word of the photographing instruction). The photographing start determination unit 334 displays the reference image on the display unit 220. The photographing start determination unit 334 may determine whether the reference image satisfies the condition of the photographing instruction by confirming to the user whether the photographing instruction is satisfied. The photographing control unit 335 performs control to perform photographing based on the reference image acquired by the reference image acquisition unit 333.

The transmission/reception unit 336 controls communication with the feature estimation server 102 and communication with the reference image generation server 103. For example, the transmission/reception unit 336 transmits the prompt created by the feature acquisition unit 332 to the feature estimation server 102, and transmits the prompt created by the reference image acquisition unit 333 to the reference image generation server 103. The transmission/reception unit 336 receives the feature of the image transmitted from the feature estimation server 102 and the reference image transmitted from the reference image generation server 103.

The control unit 337 executes various processing to control each block of the automatic photographing camera 101 and control data transfer between the blocks.

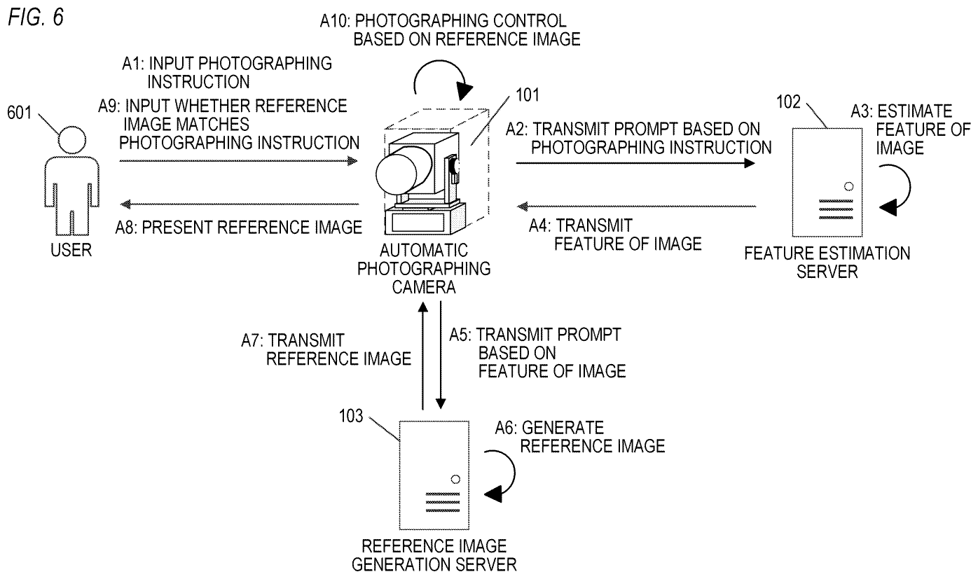

(Operation of Automatic Photographing Camera) FIG. 6 is a diagram for describing the operation of the automatic photographing camera 101. A user 601 inputs a photographing instruction by a word to the automatic photographing camera 101 (A1). The automatic photographing camera 101 creates a prompt to be used to estimate a feature of an image based on the input word of the photographing instruction and transmits the created prompt to the feature estimation server 102, thereby instructing estimation of a feature of an image to be photographed (A2). The feature estimation server 102 estimates the feature of the image to be photographed based on the prompt received from the automatic photographing camera 101 (A3). The feature estimation server 102 transmits the estimated feature of the image to the automatic photographing camera 101 (A4).

The automatic photographing camera 101 creates a prompt to be used to generate a reference image based on the feature of the image received from the feature estimation server 102 and transmits the created prompt to the reference image generation server 103, thereby instructing generation of the reference image (A5). The reference image generation server 103 generates a reference image based on the prompt received from the automatic photographing camera 101 (A6). The reference image generation server 103 transmits the generated reference image to the automatic photographing camera 101 (A7).

The automatic photographing camera 101 displays the reference image received from the reference image generation server 103 on the display unit 220 to present the reference image to the user 601 and confirms to the user whether the reference image matches the photographing instruction (whether the reference image indicates a feature estimated based on the word of the photographing instruction) (A8). The user 601 confirms whether the reference image displayed on the display unit 220 matches the photographing instruction input to the automatic photographing camera 101 in A1 and inputs a confirmation result to the automatic photographing camera 101 (A9).

When it is confirmed by the input from the user 601 that the reference image indicates the feature estimated based on the word of the photographing instruction, the automatic photographing camera 101 starts photographing control based on the reference image. Before starting the photographing control, the automatic photographing camera 101 can match its recognition with that of the user 601 regarding what kind of image is to be photographed according to the photographing instruction of the user 601.

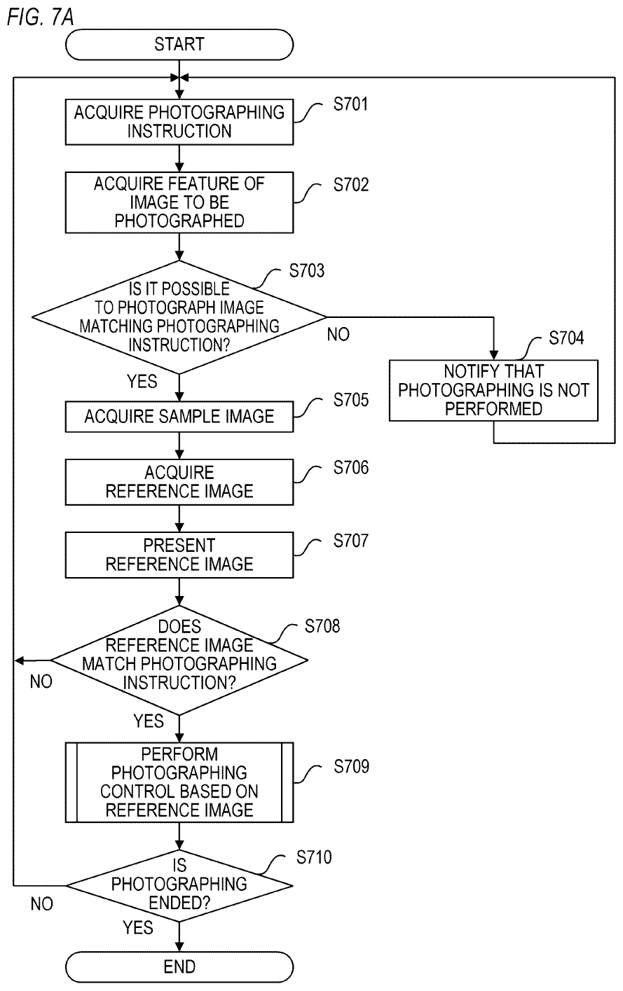

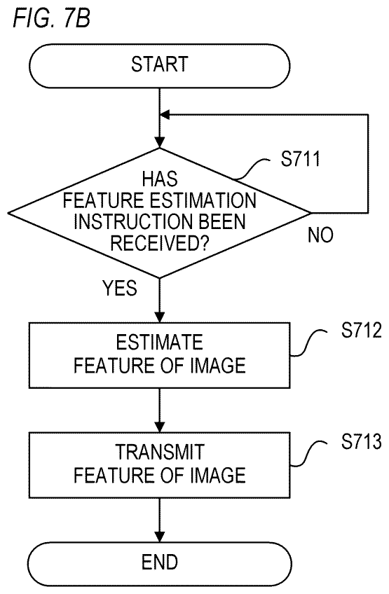

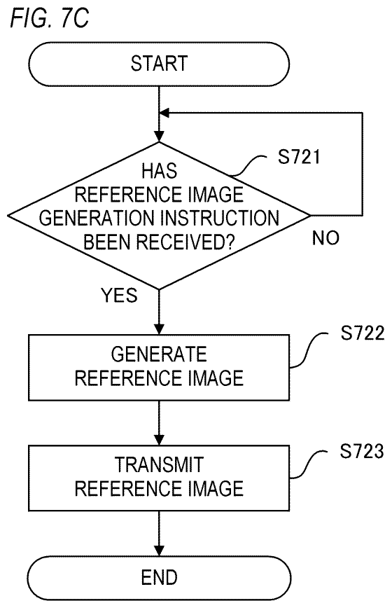

(Photographing Control Processing) Photographing control processing of the automatic photographing camera 101 will be described with reference to FIGS. 7A to 7C. FIGS. 7A to 7C illustrate processing of the automatic photographing camera 101, the feature estimation server 102, and the reference image generation server 103, respectively.

The processing of FIG. 7A is implemented by each unit illustrated in FIG. 3C by the CPU 212 of the automatic photographing camera 101 developing the program stored in the ROM 213 into the RAM 214 and executing the program. The photographing control processing illustrated in FIG. 7A is started, for example, by turning on a main power of the automatic photographing camera 101. In the photographing control processing, the user can confirm what kind of picture is to be photographed according to the photographing instruction by using a reference image. Furthermore, in a case where the reference image indicates a feature estimated based on the word of the photographing instruction, the automatic photographing camera 101 performs control to perform photographing based on the reference image.

In step S701, the photographing instruction acquisition unit 331 accepts a photographing instruction by a word via the input unit 217. In a case where the input unit 217 is a microphone, the photographing instruction acquisition unit 331 acquires an audio signal from the microphone processed by the audio processing unit 327 as a photographing instruction. For example, the photographing instruction acquisition unit 331 recognizes a voice of the user and accepts a photographing instruction by a word uttered by the user. In a case where the input unit 217 is an operation unit (operation member) such as a button, the photographing instruction acquisition unit 331 may accept a word input via the operation unit as a photographing instruction. The photographing instruction acquisition unit 331 may accept a word received from the external device as a photographing instruction.

In step S702, the feature acquisition unit 332 acquires a feature of an image to be photographed based on the photographing instruction acquired in step S701. The feature acquisition unit 332 instructs the feature estimation server 102 to estimate the feature of the image based on the photographing instruction and acquires the feature of the image estimated by the feature estimation server 102 based on the word of the photographing instruction.

In step S703, the feature acquisition unit 332 determines whether it is possible to photograph an image matching the photographing instruction (an image indicating a feature estimated based on the word of the photographing instruction) using a function installed in the automatic photographing camera 101. In a case where the automatic photographing camera 101 does not have a function for photographing an image matching a photographing instruction, the processing proceeds to step S704. In a case where the automatic photographing camera 101 has a function for photographing an image matching a photographing instruction, the processing proceeds to step S705.

In step S704, the display control unit 329 notifies the user that photographing based on the photographing instruction is not performed since the automatic photographing camera 101 does not have a function for photographing an image matching a photographing instruction. The display control unit 329 displays, on the display unit 220, a message notifying that photographing based on a photographing instruction is not performed.

In step S705, the reference image acquisition unit 333 acquires a sample image to be used to generate a reference image. The sample image is, for example, an image of the surroundings of the automatic photographing camera 101 and may be an image photographed by rotating the lens barrel 218.

In step S706, the reference image acquisition unit 333 acquires a reference image based on the feature of the image acquired in step S702. The reference image acquisition unit 333 instructs the reference image generation server 103 to generate a reference image indicating the feature of the image and can acquire the reference image generated by the reference image generation server 103. The reference image generation server 103 can receive the sample image acquired in step S705 from the automatic photographing camera 101 and generate a reference image by using the received sample image.

In step S707, the display control unit 329 presents the reference image acquired in step S706 to the user by displaying the reference image on the display unit 220. The display control unit 329 may present the reference image and output information on the feature of the image acquired in step S702 to the display unit 220 to notify the user. Furthermore, the display control unit 329 may present the reference image to the user by transmitting the reference image to the external device via the transmission/reception unit 336 and displaying the reference image on the display unit of the external device.

In step S708, the photographing start determination unit 334 determines whether the reference image matches the photographing instruction (whether the reference image indicates the feature estimated based on the word of the photographing instruction). The photographing start determination unit 334 may confirm to the user whether the reference image matches the photographing instruction. The user inputs, via the input unit 217, whether the reference image displayed on the display unit 220 matches the photographing instruction. Furthermore, the photographing start determination unit 334 may communicate with the external device via the transmission/reception unit 336 to determine whether the reference image matches the photographing instruction. When the reference image matches the photographing instruction, the processing proceeds to step S709. When the reference image does not match the photographing instruction, the processing returns to step S701.

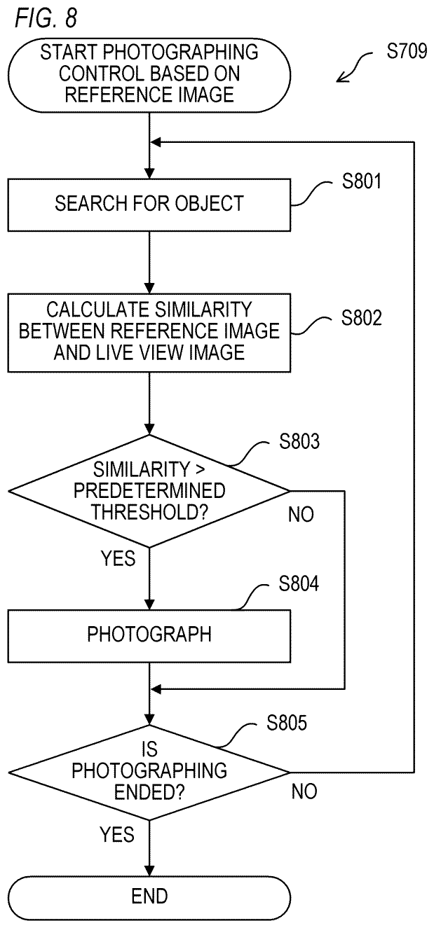

In step S709, the photographing control unit 335 performs control to perform photographing based on the reference image. Details of the photographing control based on the reference image will be described later with reference to FIG. 8.

In step S710, the control unit 337 determines whether to end photographing. In a case where the main power of the automatic photographing camera 101 is turned off or in a case where an instruction to end photographing is input via the input unit 217, the control unit 337 determines to end photographing. In a case where it is determined to end photographing, the processing illustrated in FIG. 7A ends. In a case where it is determined not to end photographing, the processing returns to step S701.

FIG. 7B is a flowchart illustrating processing of the feature estimation server 102. The processing of FIG. 7B is implemented by each unit illustrated in FIG. 3A by the CPU 202 of the feature estimation server 102 developing the program stored in the ROM 203 into the RAM 204 and executing the program.

In step S711, the transmission/reception unit 301 determines whether a feature estimation instruction of an image to be photographed has been received from the automatic photographing camera 101. The transmission/reception unit 301 receives information of a photographing instruction together with the image feature estimation instruction. The transmission/reception unit 301 receives, for example, a prompt including information of the photographing instruction. The transmission/reception unit 301 may receive the photographing instruction as the image feature estimation instruction. In a case where the image feature estimation instruction has been received, the processing proceeds to step S712. In a case where the image feature estimation instruction has not been received, the processing returns to step S711.

In step S712, the feature estimation unit 302 estimates the feature of the image to be photographed based on the photographing instruction. In step S713, the transmission/reception unit 301 transmits the feature of the image estimated in step S712 to the automatic photographing camera 101.

FIG. 7C is a flowchart illustrating processing of the reference image generation server 103. The processing of FIG. 7C is implemented by each unit illustrated in FIG. 3B by the CPU 202 of the reference image generation server 103 developing the program stored in the ROM 203 into the RAM 204 and executing the program.

In step S721, the transmission/reception unit 311 determines whether a reference image generation instruction has been received from the automatic photographing camera 101. The transmission/reception unit 311 receives the feature of the image estimated by the feature estimation server 102 together with the reference image generation instruction. The transmission/reception unit 311 receives, for example, a prompt including the feature of the image. The transmission/reception unit 311 may receive the feature of the image as the reference image generation instruction. When the reference image generation instruction has been received, the processing proceeds to step S722. In a case where the reference image generation instruction has not been received, the processing returns to step S721.

In step S722, the reference image generation unit 312 generates a reference image based on the feature of the image. In step S723, the transmission/reception unit 311 transmits the reference image generated in step S722 to the automatic photographing camera 101.

By the processing described with reference to FIGS. 7A to 7C, the automatic photographing camera 101 can control photographing by accepting a photographing instruction by a word from the user without being limited to preset automatic photographing. Furthermore, the automatic photographing camera 101 acquires a reference image for confirming what kind of image is to be photographed based on the photographing instruction and presents the reference image to the user. Therefore, before the automatic photographing camera 101 starts photographing, the user can confirm in advance whether the image to be photographed by the user matches the image to be photographed by the automatic photographing camera 101 according to the photographing instruction (whether the image has the feature according to the photographing instruction).

(Photographing Control Processing Based on Reference Image) The photographing control processing based on the reference image will be described with reference to FIG. 8. The processing of FIG. 8 is implemented by each unit illustrated in FIG. 3C by the CPU 212 of the automatic photographing camera 101 developing the program stored in the ROM 213 into the RAM 214 and executing the program.

In step S801, the photographing control unit 335 searches for an object. For example, the photographing control unit 335 changes a photographing direction by the automatic photographing camera 101 by rotating the lens barrel 218 in a pan direction or a tilt direction by the lens barrel control unit 323. The photographing control unit 335 searches for an object that satisfies a photographing instruction by changing the photographing direction.

In step S802, the image analysis unit 325 calculates a similarity between a reference image and a live view image captured by the automatic photographing camera 101 and displayed on the display unit 220 in real time. The similarity between the reference image and the live view image is, for example, a similarity for a type of the object, a facial expression of the object, a posture of the object, and a position of the object. The type of an object is a type such as a person, an animal, an object, or the like.

The similarity for the type of the object is set higher in a case where the type of the object matches between the reference image and the live view image than in a case where the types do not match. The similarity for the facial expression of the object increases as the facial expression of the object is similar between the reference image and the live view image. The similarity for the posture of the object increases as the posture of the object is similar between the reference image and the live view image. The similarity for the position of the object increases as a distance between the position of the object in the reference image and the position of the object in the live view image decreases.

In step S803, the photographing control unit 335 determines whether the similarity calculated in step S802 is greater than a predetermined threshold. For example, the photographing control unit 335 may determine whether the similarities for the type of the object, the facial expression of the object, the posture of the object, and the position of the object are each greater than a predetermined threshold. Furthermore, the photographing control unit 335 may determine whether an average value of the similarities is greater than a predetermined threshold. The predetermined threshold may be set or changed by the user. In a case where the similarity is greater than the predetermined threshold, the processing proceeds to step S804. In a case where the similarity is equal to or smaller than the predetermined threshold, the processing proceeds to step S805.

In step S804, since the similarity between the reference image and the live view image is greater than the predetermined threshold, the photographing control unit 335 performs control to perform photographing of the object. The image recording unit 326 records the photographed image processed by the image processing unit 324 in the HDD 215.

In step S805, the photographing control unit 335 determines whether to end photographing. For example, in a case where the tracking of the object has failed (lost), the photographing control unit 335 determines not to end photographing. Furthermore, in a case where the photographing has been performed a predetermined number of times based on the reference image, the photographing control unit 335 may determine not to end photographing. In a case where it is determined not to end photographing, the photographing control unit 335 returns to step S801 and searches for another object.

On the other hand, in a case where an image substantially matching the reference image can be photographed, the photographing control unit 335 determines to end photographing. In addition, the photographing control unit 335 may also determine to end photographing when the image substantially matching the reference image has not been photographed for a predetermined time. In a case where it is determined to end photographing, the processing illustrated in FIG. 8 ends.

According to the first embodiment, the automatic photographing camera 101 acquires the reference image based on the word of the photographing instruction, and performs photographing based on the reference image. The automatic photographing camera 101 can search for and photograph an object similar to the object of the reference image by changing the photographing direction. Furthermore, by presenting the reference image to the user, the automatic photographing camera 101 can confirm to the user whether the reference image indicates the feature estimated based on the word of the photographing instruction.

### Second Embodiment

In the first embodiment, the reference image generation server 103 generates the reference image based on the feature of the image estimated by the feature estimation server 102. On the other hand, in a second embodiment, the automatic photographing camera 101 acquires a reference image from among images (images photographed so as to indicate a feature estimated based on a word of a photographing instruction) photographed in the past so as to match a photographing instruction. Specifically, the automatic photographing camera 101 accumulates images photographed in the past based on a feature of the image estimated by the feature estimation server 102 in a database, and searches the database, thereby acquiring a reference image corresponding to the feature of the image estimated from the photographing instruction. In the second embodiment, the automatic photographing system includes a reference image search server 901 instead of the reference image generation server 103 of the first embodiment. Description common to the first embodiment will be omitted.

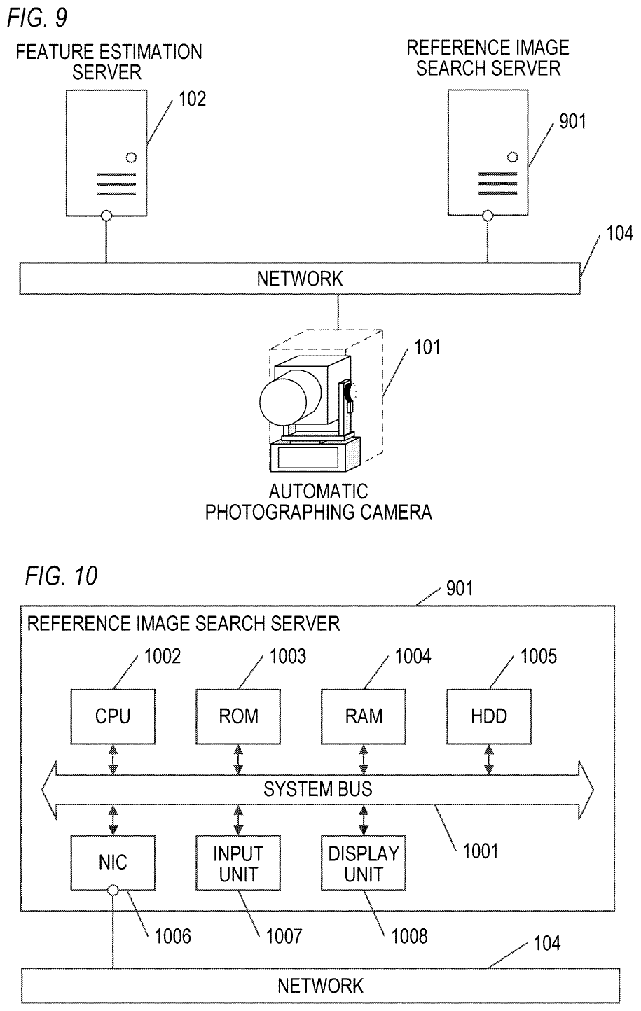

(System Configuration) FIG. 9 is a diagram illustrating a configuration of an automatic photographing system according to a second embodiment. In the example of FIG. 9, the automatic photographing system includes the automatic photographing camera 101, the feature estimation server 102, and the reference image search server 901. The automatic photographing camera 101, the feature estimation server 102, and the reference image search server 901 can communicate with each other via the network 104 such as the Internet. Note that a part of the processing of the feature estimation server 102 and the reference image search server 901 may be executed by the automatic photographing camera 101. In addition, the feature estimation server 102 and the reference image search server 901 may be configured integrally with the automatic photographing camera 101. That is, the function of each server may be implemented by the automatic photographing camera 101.

The reference image search server 901 receives a feature of the image estimated by the feature estimation server 102 from the automatic photographing camera 101 and acquires a reference image indicating the feature of the received image. The reference image search server 901 is an information processing device such as a personal computer (PC).

When accepting a photographing instruction from the user, the automatic photographing camera 101 transmits the photographing instruction to the feature estimation server 102. When receiving the feature of the image estimated by the feature estimation server 102, the automatic photographing camera 101 transmits the feature of the image to the reference image search server 901. When receiving the reference image from the reference image search server 901, the automatic photographing camera 101 displays the reference image on the display unit 220 included in the automatic photographing camera 101. The automatic photographing camera 101 may transmit the reference image to an external device including a display unit to display the reference image.

(Hardware Configuration) FIG. 10 is a diagram illustrating a hardware configuration of the reference image search server 901 included in the automatic photographing system in FIG. 9.

The reference image search server 901 includes a CPU 1002, a ROM 1003, a RAM 1004, an HDD 1005, an NIC 1006, an input unit 1007, and a display unit 1008. The components are connected to each other via a system bus 1001.

The CPU 1002 implements various functions of the reference image search server 901 by developing a program stored in the ROM 1003 into the RAM 1004 and executing the program. The ROM 1003 stores various programs for implementing processing executed by the reference image search server 901. The RAM 1004 temporarily stores data used by various programs.

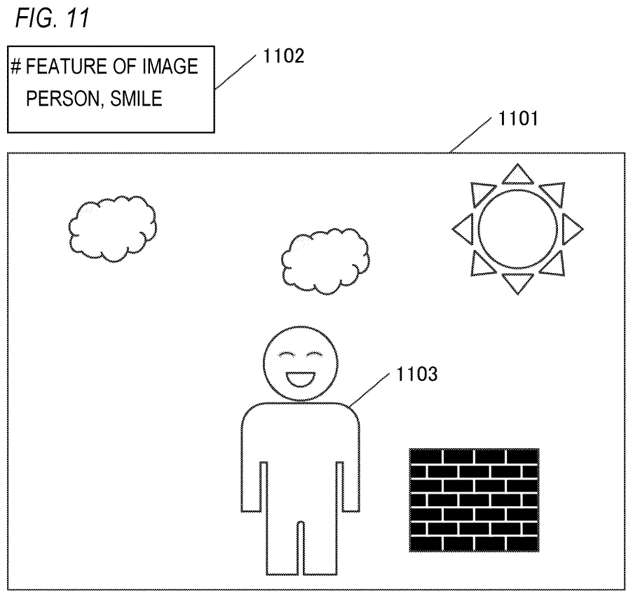

The HDD 1005 stores a combination of an image photographed in the past and a feature of the corresponding image. FIG. 11 is a diagram illustrating a combination of an image and a feature of the image. In FIG. 11, an image 1101 photographed in the past is an image in which a smiling person is photographed. A feature 1102 of the image corresponding to the image 1101 includes features of “person” and “smile”.

The HDD 1005 stores a plurality of combinations of images and features of the images. The HDD 1005 can provide reference images corresponding to various photographing instructions by accumulating data of the combinations of features of various images and images corresponding thereto.

The NIC 1006 is connected to the network 104. The NIC 1006 transmits and receives data to and from the external automatic photographing camera 101 and the like via the network 104. The NIC 1006 includes a communication circuit capable of communicating in a communication scheme conforming to various standards for transmitting and receiving information via the Internet, a dedicated line, or the like.

The input unit 1007 includes an input device such as a keyboard and a mouse that accepts an input operation with respect to the reference image search server 901. The display unit 1008 displays various types of information on the reference image search server 901.

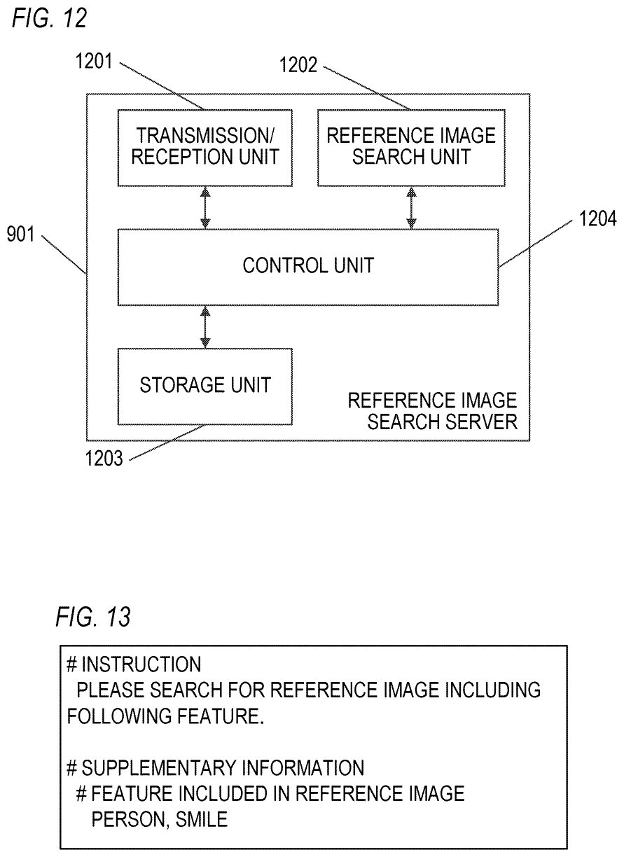

(Functional Configuration) FIG. 12 is a diagram illustrating a functional configuration of the reference image search server 901. Each functional unit of the reference image search server 901 is implemented by the CPU 1002 developing the program stored in the ROM 1003 into the RAM 1004 and executing the program. The reference image search server 901 includes a transmission/reception unit 1201, a reference image search unit 1202, a storage unit 1203, and a control unit 1204.

The transmission/reception unit 1201 communicates with the automatic photographing camera 101 to transmit and receive various data. For example, the transmission/reception unit 1201 receives a prompt transmitted from the automatic photographing camera 101 and transmits a reference image searched and acquired by the reference image search unit 1202 to the automatic photographing camera 101.

FIG. 13 is a diagram illustrating a prompt received by the reference image search server 901 from the automatic photographing camera 101. The prompt given by the automatic photographing camera 101 to the reference image search server 901 includes a reference image search instruction and supplementary information for supplementing the search instruction. The supplementary information is a feature included in the searched reference image. In the example of FIG. 13, the features included in the reference image are “person” and “smile”.

The reference image search unit 1202 searches for a reference image based on a prompt regarding the reference image search. The reference image search unit 1202 calculates a relevance between the feature of the image recorded in the HDD 1005 and the feature included in the reference image designated in the prompt. The reference image search unit 1202 acquires, as a reference image, an image having a highest relevance between the feature of the image and the feature designated in the prompt among the images recorded in the HDD 1005.

The relevance is a score for selecting an image indicating a feature included in the reference image designated in the prompt from the images recorded in the HDD 1005. The relevance is higher for images having more features in common with the features designated in the prompt. The relevance is lower for images having fewer features in common with the features designated in the prompt.

The storage unit 1203 stores the combination of the image and the feature of the image. The control unit 1204 executes various processing to control each functional unit of the reference image search server 901 and control data transfer between the functional units.

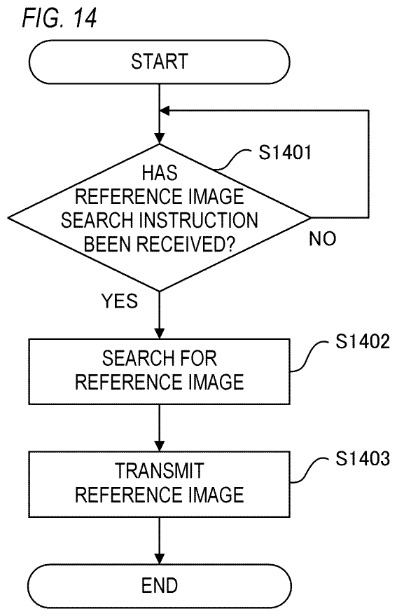

(Reference Image Search Processing) FIG. 14 is a flowchart illustrating reference image search processing by the reference image search server 901. The reference image search server 901 searches for a reference image to be presented to the user from the images recorded in the HDD 1005 based on the feature of the image received from the automatic photographing camera 101 and transmits the reference image to the automatic photographing camera 101. The processing of FIG. 14 is implemented by each unit illustrated in FIG. 12 by the CPU 1002 of the reference image search server 901 developing the program stored in the ROM 1003 into the RAM 1004 and executing the program.

In step S1401, the transmission/reception unit 1201 determines whether a reference image search instruction has been received from the automatic photographing camera 101. The transmission/reception unit 1201 receives a feature of the image estimated by the feature estimation server 102 together with the reference image search instruction. The transmission/reception unit 1201 may receive the feature of the image as the reference image search instruction. In a case where the reference image search instruction has been received, the processing proceeds to step S1402. In a case where the reference image search instruction has not been received, the processing returns to step S1401.

In step S1402, the reference image search unit 1202 searches for a reference image based on the feature of the image. In step S1403, the transmission/reception unit 1201 transmits the reference image searched in step S1402 to the automatic photographing camera 101.

In the second embodiment described above, the reference image search server 901 searches for the image recorded in the HDD 1005 based on the feature of the image received from the automatic photographing camera 101 and acquires the reference image to be presented to the user. The reference image search server 901 transmits the acquired reference image to the automatic photographing camera 101.

The present disclosure includes a case where a program of software that implements the functions of the above-described embodiments is supplied from a recording medium directly or by using wired/wireless communication to a system or a device having a computer capable of executing the program, and the supplied program is executed. In order to implement the functions of the above-described embodiments on a computer, program code itself supplied or installed on the computer also implements the present disclosure. That is, a computer program for implementing the functions of the embodiments is included in the present disclosure. As long as the computer program has a function of a program, the computer program may be an object code, a program executed by an interpreter, script data supplied to an OS, or the like, and the form of the program is not limited.

The recording medium for supplying the program may be, for example, a hard disk, a magnetic recording medium such as a magnetic tape, an optical/magneto-optical storage medium, or a non-volatile semiconductor memory. As a method for supplying the program, a computer program for implementing the present disclosure may be stored in a server on a computer network, and a client computer connected to the server may download the computer program.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, a user can confirm in advance whether a desired image is to be photographed in automatic photographing based on a photographing instruction from the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-114878, filed on Jul. 18, 2024, which is hereby incorporated by reference herein in its entirety.

What is claimed is:

1. An imaging device comprising:
a processor; and
a memory storing a program which, when executed by the processor, causes the imaging device to:
execute acceptance processing of accepting a photographing instruction by a word;
execute an acquisition processing of acquiring a reference image based on the word of the photographing instruction;
execute notification processing of presenting the reference image to a user; and
execute control processing of performing control to perform photographing based on the reference image.

2. The imaging device according to claim 1, wherein
in the acquisition processing, a feature of an image to be photographed is estimated based on the word of the photographing instruction, and the reference image indicating an estimated feature is acquired.

3. The imaging device according to claim 2, wherein
in the acquisition processing, the reference image is generated based on the estimated feature.

4. The imaging device according to claim 1, wherein
in the notification processing, in a case where the imaging device does not have a function for photographing an image indicating a feature estimated based on the word of the photographing instruction, the user is notified that photographing based on the photographing instruction is not performed.

5. The imaging device according to claim 1, wherein
in the acquisition processing, the reference image is generated by using an image photographed by the imaging device.

6. The imaging device according to claim 1, wherein
in the acquisition processing, the reference image is generated by using an image photographed in a past so as to indicate a feature estimated based on the word of the photographing instruction.

7. The imaging device according to claim 1, wherein
in the notification processing, the reference image is presented, and the user is notified of information on a feature estimated based on the word of the photographing instruction.

8. The imaging device according to claim 1, further comprising:
a camera capable of changing a photographing direction, wherein
in the control processing, the camera is controlled to search an object satisfying the photographing instruction by changing the photographing direction of the camera, and to photograph a detected object.

9. The imaging device according to claim 1, wherein
in the notification processing, the reference image is presented to the user by displaying the reference image on a display.

10. The imaging device according to claim 1, wherein
in the notification processing, the reference image is presented to the user by transmitting the reference image to an external device and displaying the reference image on a display of the external device.

11. The imaging device according to claim 1, wherein
in the acceptance processing, a voice of the user is recognized, and the photographing instruction by a word uttered by the user is accepted.

12. The imaging device according to claim 1, wherein
in the acceptance processing, a word received from an external device is accepted as the photographing instruction.

13. The imaging device according to claim 1, wherein
in the acceptance processing, a word input via an operation unit is accepted as the photographing instruction.

14. The imaging device according to claim 1, wherein
in the control processing, control is performed such that photographing is performed in a case where a similarity between the reference image and a live view image is greater than a predetermined threshold.

15. The imaging device according to claim 1, wherein
in the acquisition processing, the reference image is acquired from among images photographed in a past so as to indicate a feature estimated based on the word of the photographing instruction.

16. The imaging device according to claim 1, wherein
in the notification processing, whether the reference image indicates a feature estimated based on the word of the photographing instruction is confirmed by the user, and
in the control processing, in a case where the user confirms that the reference image indicates the feature, control is performed such that photographing is performed based on the reference image.

17. A method for controlling an imaging device, comprising:
accepting a photographing instruction by a word;
acquiring a reference image based on the word of the photographing instruction;
presenting the reference image to a user; and
performing control to perform photographing based on the reference image.

18. A non-transitory computer readable medium that stores a program, wherein the program causes a computer to execute a method for controlling an imaging device, the method comprising:
accepting a photographing instruction by a word;
acquiring a reference image based on the word of the photographing instruction;
presenting the reference image to a user; and
performing control to perform photographing based on the reference image.
